(19) United States
(12) Patent Application Publication
(10) Pub. No.: US 2018/0293877 A1
(43) Pub. Date: Oct. 11, 2018

(54) NETWORK-BASED FACILITY MAINTENANCE

(71) Applicant: Intel IP Corporation, Santa Clara, CA (US)

(72) Inventor: Hans-Joachim Barth, Munich (DE)

(73) Assignee: Intel IP Corporation, Santa Clara, CA (US)

(21) Appl. No.: 15/767,474

(22) PCT Filed: Dec. 21, 2015
(86) PCT No.: PCT/US15/67128

§ 371 Date: Apr. 11, 2018

(51) Int. Cl. G08B 25/14; G06Q 10/06; G06Q 50/16; G08B 21/18; G08B 25/10; G01F 23/30; G01F 23/00

(52) U.S. Cl. CPC G08B 25/14; G06Q 10/0631; G06Q 50/163; G01F 23/0061; G08B 25/10; G01F 23/30; G08B 21/182

(57) ABSTRACT

In one embodiment an electronic device includes a sensor apparatus, comprising at least one sensor to detect a reading for an environmental condition proximate the sensor apparatus, logic, at least partially including hardware logic, configured to detect an abnormal reading in the environmental condition, generate an alert in response to the abnormal reading and a communication interface to transmit the alert to a remote electronic device. Other embodiments may be described.

### BACKGROUND

The subject matter described herein relates generally to the field of electronic devices and more particularly to network-based facility maintenance.

Public facilities such as wash rooms and toilets (e.g., in train stations, airports, public buildings, schools, shopping malls, hospitals, companies, etc.) frequently suffer from inadequate attention to basic functionality of fixtures such as toilets, urinals, sinks, and supplies. In some cases the waste and drain-pipe of the toilet bowl, urinal or sink may be clogged. This results in stagnant or even overflowing sewage water. Accordingly additional systems and techniques to provide network-based facility maintenance may find utility.

### BRIEF DESCRIPTION OF THE DRAWINGS

The detailed description is described with reference to the accompanying figures.

FIGS. 1A-1E are schematic illustrations of a plumbing fixture which may be adapted to implement network-based facility maintenance in accordance with some embodiments.

FIG. 2 is a high-level schematic illustration of a sensor apparatus for network-based facility maintenance in accordance with some embodiments.

FIG. 3 is a schematic illustration of an electronic device which may be adapted to implement a maintenance controller in accordance with some embodiments.

FIG. 4 is a flowchart illustrating operations in a method to implement network-based facility maintenance in accordance with some embodiments.

FIGS. 5A-5B are graphs illustrating operating parameters of a plumbing fixture which may be used in techniques for network-based facility maintenance in accordance with some embodiments.

FIGS. 6A-6B are schematic illustrations of plumbing fixtures which may be adapted to implement network-based facility maintenance in accordance with some embodiments.

### DETAILED DESCRIPTION

Described herein are exemplary systems and methods to implement network-based facility maintenance. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

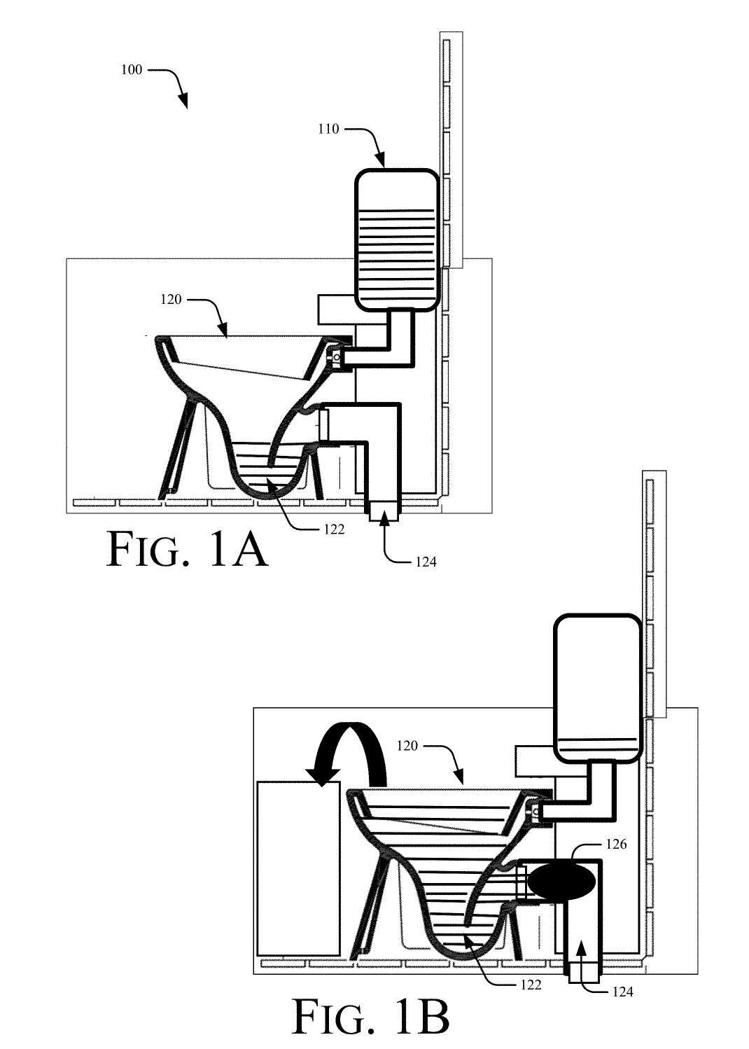

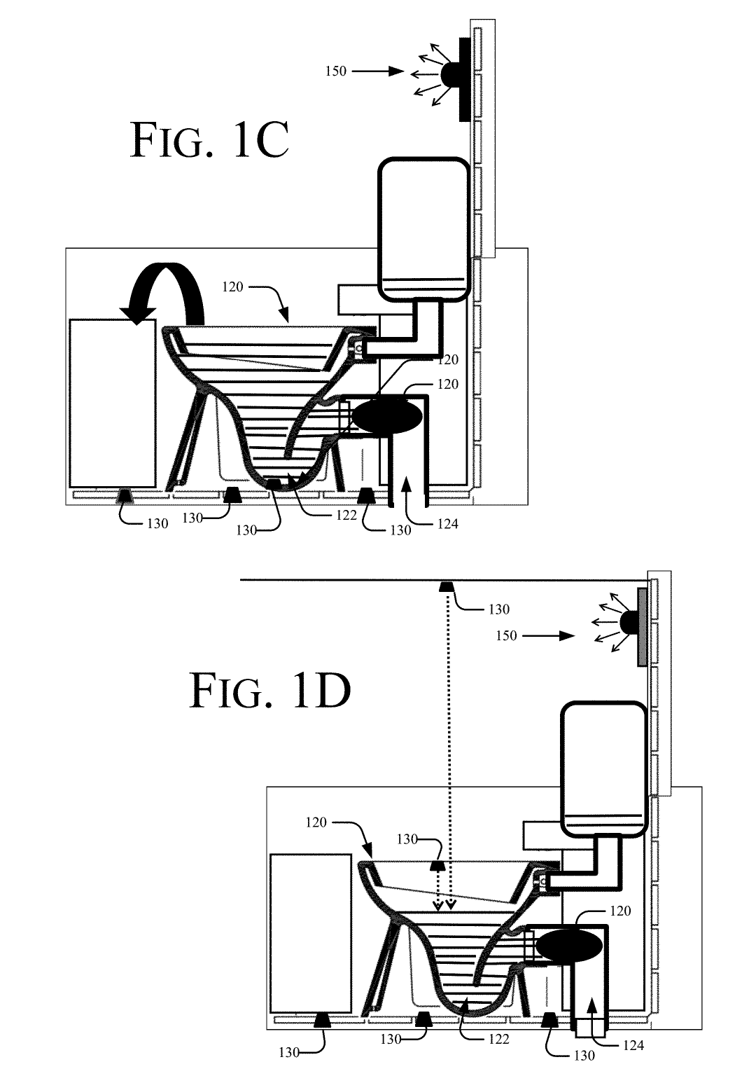

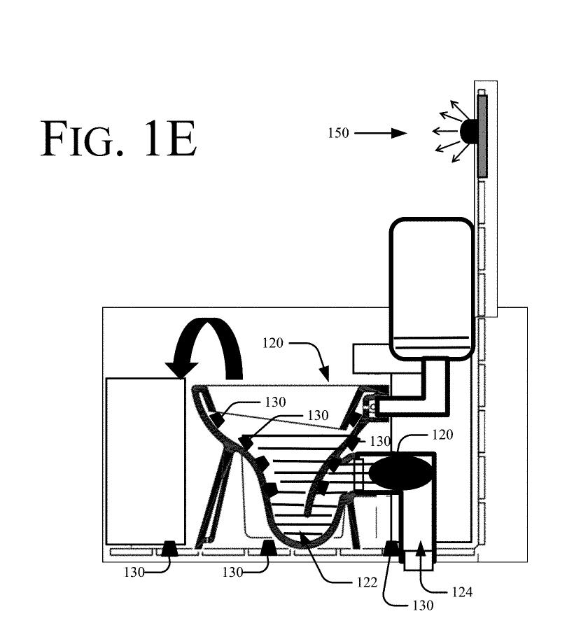

In some embodiments described herein one or more sensor apparatus comprising sensors and/or water level indicators may be positioned in or proximate plumbing fixtures such as toilet bowls, urinals, sinks, fluid dispensers or the like. These sensors are communicatively connected with a maintenance center of the respective building or company. When a sensor detects an abnormal reading in an environmental condition (e.g., a fluid level, a fluid pressure, or a fluid flow rate) which might indicate that fluid is not flowing normally, the sensor may generate and transmit an alert signal to the maintenance team via a suitable communication link. This alert may include the location, a timestamp, and a device identifier of the defective plumbing fixture and a first indication of the problem. Further, the alert may generate a warning signal at a location proximate the defective fixture (e.g. attached to the wall, etc.) to indicate that the fixture is out of order. Similar sensors can be implemented in dispensers of (liquid) soap, paper towels, toilet paper, etc. in order to send alert signals to the maintenance team as soon as the supply is running low. Additional details and features will be described with reference to FIGS. 1-7, below.

FIG. 1A is a schematic depiction of a plumbing fixture, e.g., a toilet 100. Referring to FIG. 1A, in brief summary toilet 100 comprises a tank 110 which is filled with water or other fluid and a bowl 120 to receive waste products. Bowl 120 comprises a trap 122 that remains filled with water under normal operating conditions in order to prevent noxious gases in the sewer system from flowing through the trap 122. In operation, when toilet 100 is flushed, water from the tank 110 flows into the bowl 120 which develops sufficient head pressure in the bowl 120 to cause water and waste products to flow through the trap 122 and out the drain pipe 124 to the sewer system.

Referring to FIG. 1B, when the drain pipe 124 is blocked by an object 126 in the drain pipe (or the bowl 120) water flow through the drain pipe 124 is impeded. This can result in the bowl 120 overflowing onto the floor, creating an unsanitary and unsightly condition.

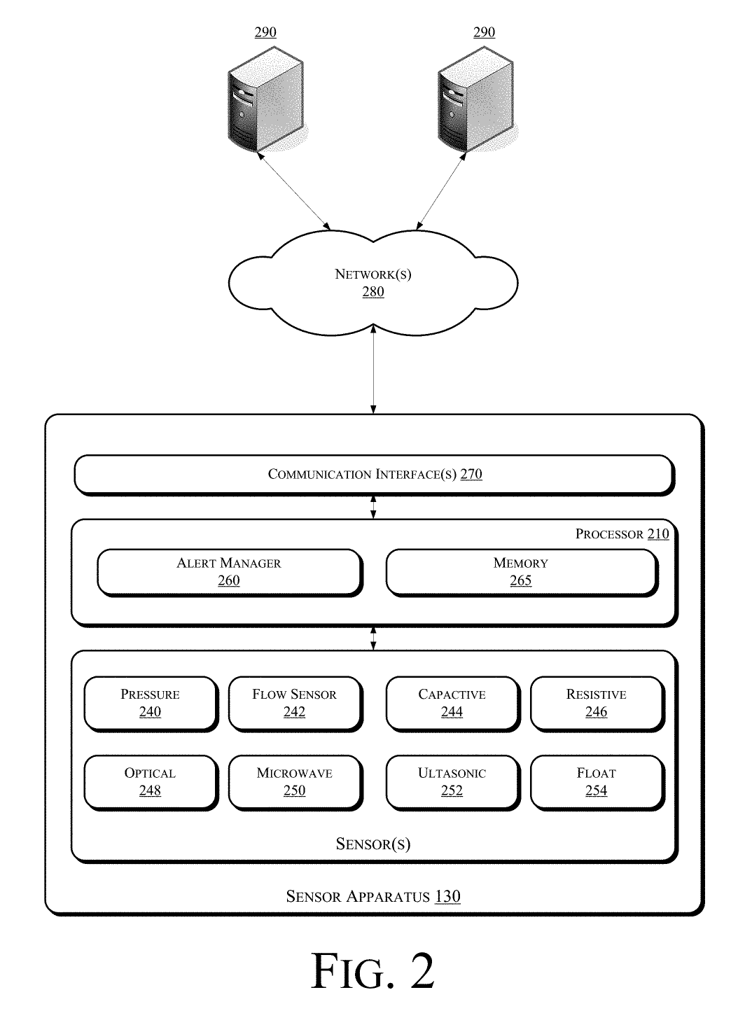

To address this and other issues, described herein are systems, components, and techniques to implement network-based facility maintenance. In some examples one or more sensor apparatus 130 may be positioned proximate a plumbing fixture such as the toilet 100. Referring to FIG. 2, in some examples a sensor apparatus 130 may comprise one or more sensors communicatively coupled to a processor 210. Sensors may include one or more of a pressure sensor 240, a flow sensor 242, a capacitive sensor 244, a resistive sensor 246, an optical sensor 248, a microwave sensor 250, an ultrasonic sensor 252, or a float sensor 254. Sensor apparatus 200 may further comprise one or more communication interface(s) 270 to provide a communication connection with one or more remote electronic devices such as a maintenance controller 290 via one or more networks 280.

In some examples, communication interface 270 may be a wired interface such as an Ethernet interface (see, e.g., Institute of Electrical and Electronics Engineers/IEEE 802.3-2002). Alternatively, communication interface may be a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

In some examples the communication network(s) 280 may comprise a public communication network such as, e.g., the internet, or as a private communication network, or combinations thereof. Remote electronic device 290 may comprise one or more computing devices associated with a maintenance center for the facility which maintains the toilet 100.

In some examples processor 210 may comprise any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some embodiments, processor 210 may be one or more processors in the family of Intel® PXA27x processors available from Intel® Corporation of Santa Clara, Calif. Alternatively, other CPUs may be used, such as Intel's Itanium®, XEON®, ATOM™, and Celeron® processors. Also, one or more processors from other manufactures may be utilized. Moreover, the processor(s) may have a single or multi core design.

Processor 210 may comprise, or be communicatively coupled to, a local memory 265. In some embodiments, memory module 265 may comprise random access memory (RAM); however, memory 265 may comprise other memory types such as dynamic RAM (DRAM), synchronous DRAM (SDRAM), and the like. Memory 240 may comprise logic instructions which execute on the processor(s) 210.

Referring to FIG. 1C, in some examples one or more sensor apparatus 130 may be positioned on the floor proximate the toilet 100 or in the toilet bowl 120. In some examples the sensor apparatus 130 on the floor may comprise one or more resistance-based sensors 246 or capacitive sensors 244 capable to detect the presence of fluid (e.g., water) on the floor proximate the toilet 100 or in the toilet bowl 120. Further a sensor apparatus 130 positioned in the trap 122 may measure the water pressure in at the bottom of the trap 122.

Referring to FIG. 1D, in some examples one or more sensor apparatus 130 may be positioned on the ceiling above the toilet 100 and/or proximate an upper surface of the toilet bowl 120. These sensor apparatus 130 may comprise one or more of an optical sensor 248, a microwave sensor 250, or an ultrasonic sensor which may determine a distance between the sensor apparatus 130 and the fluid level in the toilet bowl 120.

Referring to FIG. 1E, in some examples one or more sensor apparatus 130 may be positioned within the toilet bowl 120 to measure the water level and or a flow rate in the toilet bowl 120. In some examples the sensor apparatus in the toilet bowl 120 may comprise one or more resistance-based sensors 246 or capacitive sensors 244 capable to detect the presence of fluid (e.g., water) in the toilet bowl 120 and/or the drain pipe 124. Alternatively, the sensor apparatus 130 may comprise an optical sensor 248 to detect a change in optical properties (e.g., an index of refraction) between air and water or another liquid.

In some examples the alert manager 260 in the various sensor apparatus 130 may configure the processor 210 to implement operations to monitor environmental conditions (e.g., fluid levels in the toilet bowl 120, fluid pressures in the toilet bowl 120, flow rates for fluids exiting the toilet bowl 120, and wet/dry conditions proximate the toilet 100) to detect an abnormal reading in an environmental condition by one or more of the sensor apparatus 130. In response thereto, the sensor apparatus may generate an alert in response to the abnormal reading and may transmit the alert to the communication interface 270 and from there through network 280 to the maintenance controller 290 in the maintenance center of the facility.

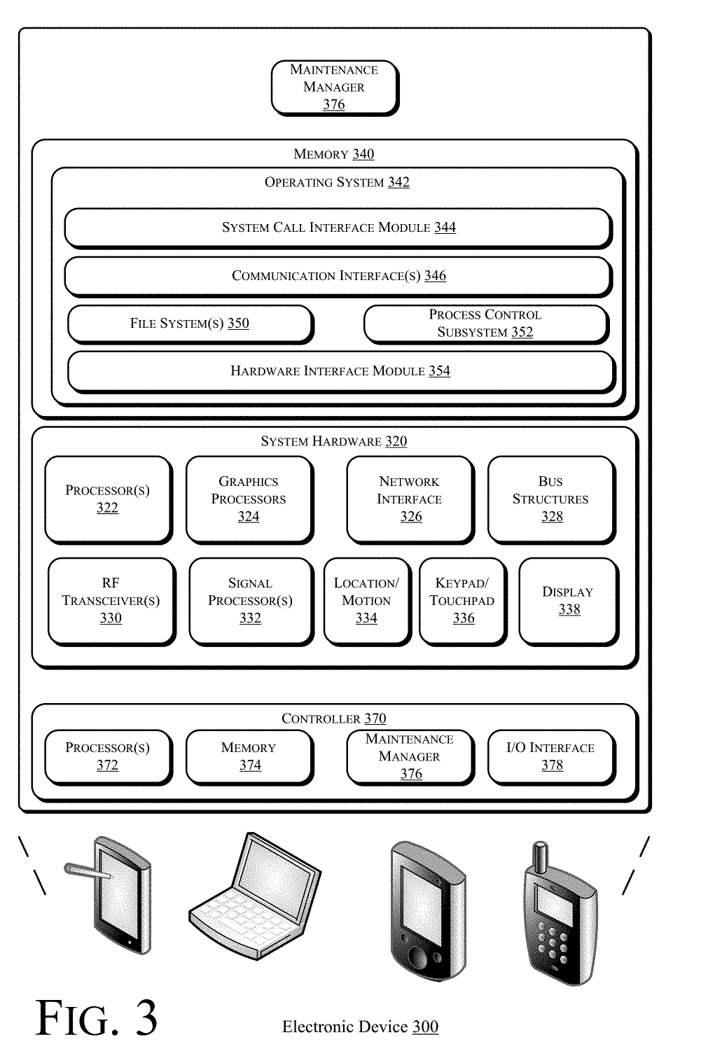

FIG. 3 is a schematic illustration of an electronic device 300 which may be adapted to implement a maintenance controller 290 in accordance with some examples. In various examples, electronic device 300 may include or be coupled to one or more accompanying input/output devices including a display, one or more speakers, a keyboard, one or more other I/O device(s), a mouse, a camera, or the like. Other exemplary I/O device(s) may include a touch screen, a voice-activated input device, a track ball, a geolocation device, an accelerometer/gyroscope, biometric feature input devices, and any other device that allows the electronic device 300 to receive input from a user.

The electronic device 300 includes system hardware 320 and memory 340, which may be implemented as random access memory and/or read-only memory. A file store may be communicatively coupled to electronic device 300. The file store may be internal to electronic device 300 such as, e.g., eMMC, SSD, one or more hard drives, or other types of storage devices. Alternatively, the file store may also be external to electronic device 300 such as, e.g., one or more external hard drives, network attached storage, or a separate storage network.

System hardware 320 may include one or more processors 322, graphics processors 324, network interfaces 326, and bus structures 328. In one embodiment, processor 322 may be embodied as an Intel® Atom™ processors, Intel® Atom™ based System-on-a-Chip (SOC) or Intel® Core2 Duo® or i3/i5/i7 series processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 324 may function as adjunct processor that manages graphics and/or video operations. Graphics processor(s) 324 may be integrated onto the motherboard of electronic device 300 or may be coupled via an expansion slot on the motherboard or may be located on the same die or same package as the Processing Unit.

In one embodiment, network interface 326 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 328 connect various components of system hardware 328. In one embodiment, bus structures 328 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

Electronic device 300 may include an RF transceiver 330 to transceive RF signals and a signal processing module 332 to process signals received by RF transceiver 330. RF transceiver may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a WCDMA, LTE, general packet radio service (GPRS) interface (see, e.g., Guidelines on GPRS Handset Requirements, Global System for Mobile Communications/GSM Association, Ver. 3.0.1, December 2002).

Electronic device 300 may further include one or more location/motion devices 334 and input/output interfaces such as, e.g., a keypad 336 and a display 338. In some examples electronic device 300 may not have a keypad and may use the touch panel for input.

Memory 340 may include an operating system 342 for managing operations of electronic device 300. In one embodiment, operating system 342 includes a hardware interface module 354 that provides an interface to system hardware 320. In addition, operating system 342 may include a file system 350 that manages files used in the operation of electronic device 300 and a process control subsystem 352 that manages processes executing on electronic device 300.

Operating system 342 may include (or manage) one or more communication interfaces 346 that may operate in conjunction with system hardware 320 to transceive data packets and/or data streams from a remote source. Operating system 342 may further include a system call interface module 344 that provides an interface between the operating system 342 and one or more application modules resident in memory 340. Operating system 342 may be embodied as a UNIX operating system or any derivative thereof (e.g., Linux, Android, etc.) or as a Windows® brand operating system, or other operating systems.

In some examples an electronic device may include a controller 370, which may comprise one or more controllers that are separate from the primary execution environment. The separation may be physical in the sense that the controller may be implemented in controllers which are physically separate from the main processors. Alternatively, the trusted execution environment may be logical in the sense that the controller may be hosted on same chip or chipset that hosts the main processors.

By way of example, in some examples the controller 370 may be implemented as an independent integrated circuit located on the motherboard of the electronic device 300, e.g., as a dedicated processor block on the same SOC die. In other examples the trusted execution engine may be implemented on a portion of the processor(s) 322 that is segregated from the rest of the processor(s) using hardware enforced mechanisms.

In the embodiment depicted in FIG. 3 the controller 370 comprises a processor 372, a memory module 374, a maintenance manager 376, and an I/O interface 378. In some examples the memory module 374 may comprise a persistent flash memory module and the various functional modules may be implemented as logic instructions encoded in the persistent memory module, e.g., firmware or software. The I/O module 378 may comprise a serial I/O module or a parallel I/O module. Because the controller 370 is separate from the main processor(s) 322 and operating system 342, the controller 370 may be made secure, i.e., inaccessible to hackers who typically mount software attacks from the host processor 322. In some examples portions of the maintenance manager 376 may reside in the memory 340 of electronic device 300 and may be executable on one or more of the processors 322.

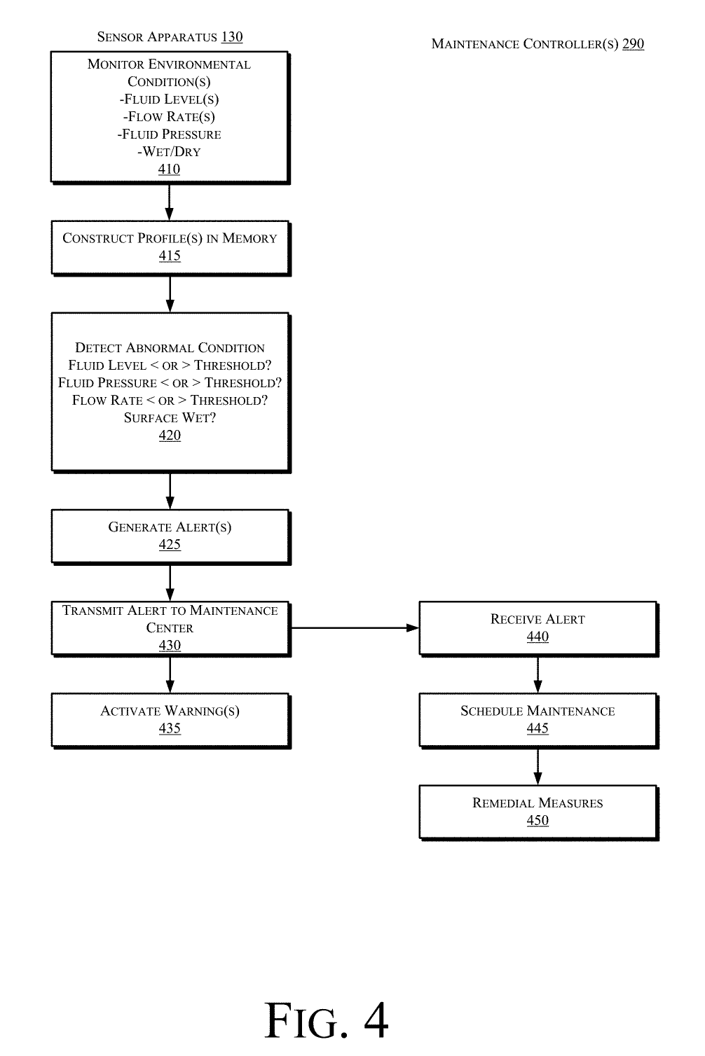

Having described various structural components of a system for network-based facility maintenance, operations to implement network-based facilities maintenance will be described. FIG. 4 is a flowchart illustrating operations in a method to implement network-based facility maintenance in accordance with some embodiments. In some examples certain operations depicted in FIG. 4 may be performed by the processor 210 in the sensor apparatus 130, while other operations may be implemented by one or more processors 322/372 in the electronic device 300 which implements the maintenance controller 290.

Referring to FIG. 4, at operation 410 one or more of the sensor apparatus 130 monitor environmental conditions proximate the sensor apparatus. As described above, some sensor apparatus 130 are configured to monitor fluid levels and/or fluid pressures in the toilet bowl 120, while other sensor apparatus may be configured to monitor flow rates flow rates for fluids exiting via the drain pipe 124. Other sensor apparatus 130 may be configured to determine whether a region proximate the sensor apparatus 130 is wet or dry.

In some examples the alert manager 260 of the sensor apparatus 130 may be configured to monitor (operation 415), on a periodic basis, one or more environmental condition readings proximate the sensor apparatus 130 and store the one or more environmental condition readings in the local memory 265 on the sensor apparatus. In some examples the alert manager 260 may optional construct one or more profiles of the environmental conditions over time. For example, the profiles may comprise a profile over time of the fluid level in a plumbing fixture, a fluid pressure in the plumbing fixture, or a flow rate for a fluid in the plumbing fixture. The profiles may be updated over time to determine at least one of a maximum fluid level in the plumbing fixture, an average fluid level in the plumbing fixture, or a minimum fluid level in the plumbing fixture.

At operation 420 the alert manager 260 in a sensor apparatus 130 may detect an abnormal condition. By way of example, a the alert manager 260 in a sensor apparatus 130 may determine whether a current reading for a fluid level in the plumbing fixture exceeds a maximum fluid level in the plumbing fixture for a threshold period of time or whether a current reading for a fluid level in the plumbing fixture is below a minimum fluid level in the plumbing fixture for a threshold period of time. Each of these conditions may indicate that the toilet needs maintenance. Alternatively, or in addition, the alert manger 260 may determine whether a fluid pressure and/or a fluid flow rate is below a minimum threshold or above a maximum threshold for a threshold period of time. Alternatively, or in addition, the alert manger 260 may determine whether a surface is wet.

In some examples the threshold may be established at least in part by the profile(s) constructed in operation 415. For example, in embodiments in which the alert manager 260 constructs a profile which includes minimum and/or maximum fluid levels, the threshold may correspond to the minimum and/or maximum fluid levels constructed in operation 415. Similarly, in embodiments in which the alert manager 260 constructs a profile which includes minimum and/or maximum fluid pressures and/or flow rates, the threshold may correspond to the minimum and/or maximum fluid pressure and/or flow rates constructed in operation 415.

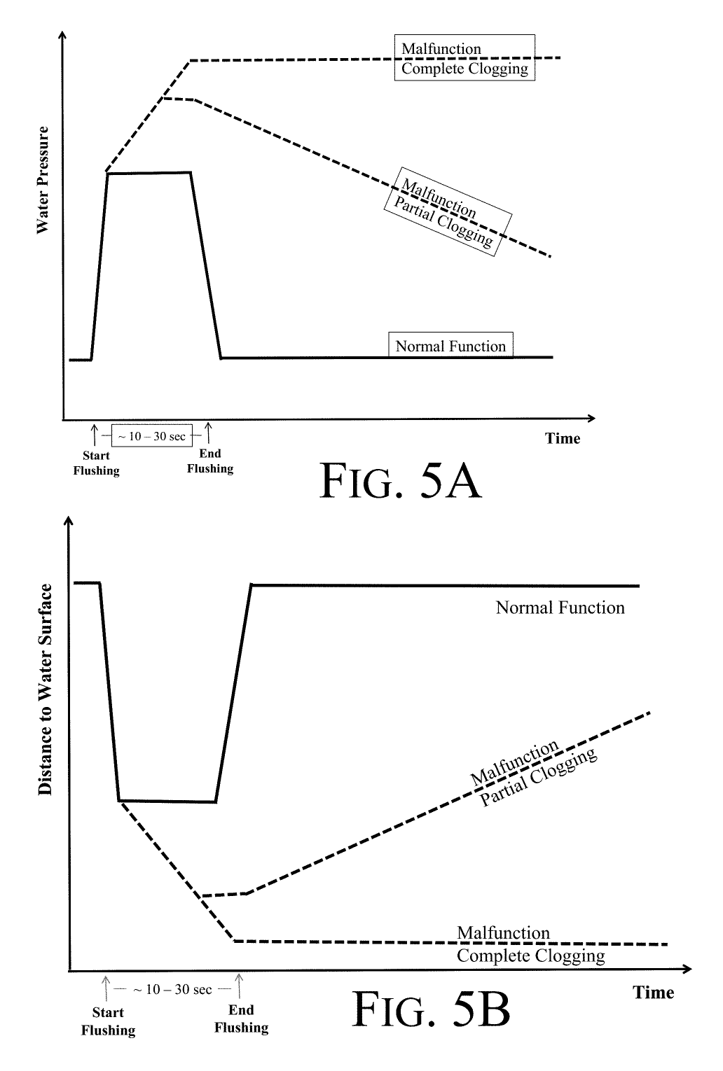

In another example the memory 265 may comprise one or more preconfigured fluid level or fluid pressure profiles which correspond to an abnormal reading in the environmental condition and the alert manager may compare a current reading for a fluid level to the one or more preconfigured fluid levels or fluid pressures for a threshold period of time. Referring to FIG. 5A, memory 265 may be configured with a profile of water pressure over time in the normal operation conditions, a condition in which the toilet 100 is partially plugged, and a condition in which the toilet is completely plugged. In this embodiment a current fluid pressure reading may be compared to the pressure data depicted in FIG. 5A to determine whether an abnormal condition exists. Similarly, referring to FIG. 5B, memory 265 may be configured with a profile of a distance between the sensor apparatus 130 and the surface of the fluid in the toilet bowl under normal operation conditions, a condition in which the toilet 100 is partially plugged, and a condition in which the toilet is completely plugged. In this embodiment a current fluid pressure reading may be compared to the pressure data depicted in FIG. 5B to determine whether an abnormal condition exists.

If an abnormal condition is detected at operation 425 the alert manager 260 generates an alert at operation 425. In some examples the alert comprises at least one of a location identifier, a time stamp, a device identifier which identifies the sensor apparatus and/or the plumbing fixture that the sensor apparatus is monitoring. The alert may also include an indication of the type of maintenance required, e.g., whether a toilet is plugged, partially plugged or the like. At operation 430 the alert is transmitted to the maintenance center, e.g., via network(s) 280.

At operation 435 the alert manager 260 may activate a warning. For example, the alert manager may activate a warning indicator 150 to indicate that the toilet 100 is out of order.

At operation 440 the maintenance controller 290 receives the alert from the sensor apparatus and at operation 445 the maintenance manager 376 may schedule a maintenance operation for the toilet 100. At operation 450 the maintenance manager 376 may implement one or more remedial measures. By way of example, the maintenance manager 376 may initiate an automatic shutoff process to the water supply source for the toilet 100 in order to prevent further spillage from toilet 100.

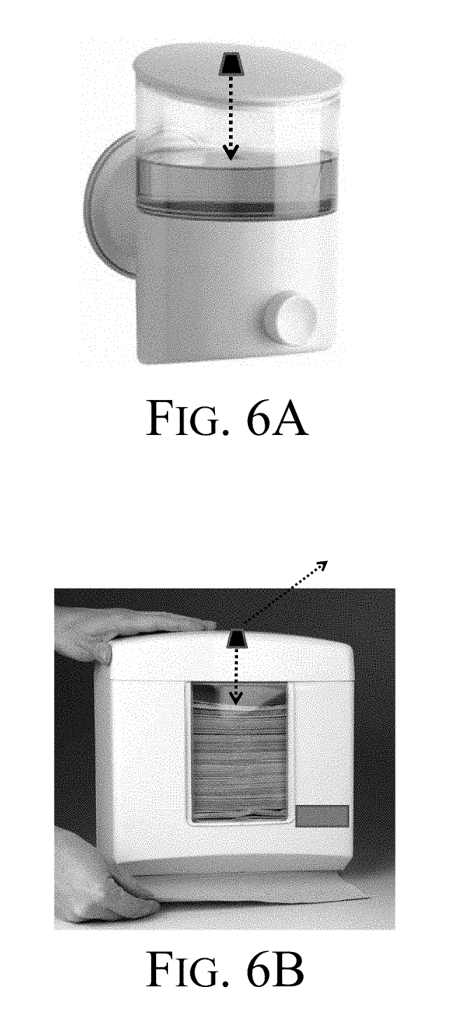

Referring briefly to FIGS. 6A and 6B, in some examples one or more sensor apparatus 130 may be used to monitor fluid levels in plumbing fixtures such as soap dispensers and/or paper towel dispensers (FIG. 6A-6B).

Thus, the structure and operations described herein provide for network-based maintenance operations. While the subject matter has been described in the context of bathroom facilities in large, public facilities, one skilled in the art will recognize that the subject matter described herein may be analyze flow rates of any type of plumbing element in any system from a small apartment to a huge complex like a sports arena or hospital. Further, the plumbing fixtures may be located in kitchens, laundry rooms, water fountains, etc. Further, sensors may be placed in locations that are not necessarily proximate a human-interaction plumbing fixture, e.g., deeper in a plumbing system. An array of sensors may be positioned throughout an entire plumbing system to measure incoming and/or outgoing flow rates throughout the system.

The following pertain to further embodiments.

Example 1 is a sensor apparatus, comprising at least one sensor to detect a reading for an environmental condition proximate the sensor apparatus, logic, at least partially including hardware logic, configured to detect an abnormal reading in the environmental condition, generate an alert in response to the abnormal reading, and a communication interface to transmit the alert to a remote electronic device.

In Example 2, the subject matter of Example 1 can optionally include an arrangement wherein the at least one sensor comprises at least one of a pressure sensor, a flow sensor, a capacitive sensor, a resistive sensor, an optical sensor, a microwave sensor, an ultrasonic sensor, or a float sensor.

In Example 3, the subject matter of any one of Examples 1-2 can optionally include an arrangement wherein sensor apparatus further comprises a local memory.

In Example 4, the subject matter of any one of Examples 1-3 can optionally include logic further configured to monitor, on a periodic basis, one or more environmental condition readings proximate the sensor apparatus, and store the one or more environmental condition readings in the local memory.

In Example 5, the subject matter of any one of Examples 1-4 can optionally include logic further configured to construct a profile of the environmental conditions over time.

In Example 6, the subject matter of any one of Examples 1-6 can optionally include at least one of a fluid level in a plumbing fixture, a fluid pressure in the plumbing fixture, or a flow rate for a fluid in the plumbing fixture.

In Example 7, the subject matter of any one of Examples 1-6 can optionally include logic, at least partially including hardware logic, to determine at least one of a maximum fluid level in the plumbing fixture, an average fluid level in the plumbing fixture, or a minimum fluid level in the plumbing fixture.

In Example 8, the subject matter of any one of Examples 1-7 can optionally include an arrangement wherein the logic to detect an abnormal reading in the environmental condition comprises logic, at least partially including hardware logic, to determine whether a current reading for a fluid level in the plumbing fixture exceeds a maximum fluid level in the plumbing fixture for a threshold period of time.

In Example 9, the subject matter of any one of Examples 1-8 can optionally include an arrangement wherein the logic to detect an abnormal reading in the environmental condition comprises logic, at least partially including hardware logic, to determine whether a current reading for a fluid level in the plumbing fixture is below a minimum fluid level in the plumbing fixture for a threshold period of time.

In Example 10, the subject matter of any one of Examples 1-9 can optionally include an arrangement wherein the memory comprises one or more preconfigured fluid level profiles which correspond to an abnormal reading in the environmental condition and the logic to detect an abnormal reading in the environmental condition comprises logic, at least partially including hardware logic, to compare a current reading for a fluid level to the one or more preconfigured fluid levels for a threshold period of time.

In Example 11, the subject matter of any one of Examples 1-10 can optionally include an arrangement wherein the logic to construct a profile of the environmental conditions over time comprises logic, at least partially including hardware logic, to determine at least one of a maximum fluid pressure in the plumbing fixture, an average fluid pressure in the plumbing fixture, or a minimum fluid pressure in the plumbing fixture

In Example 12, the subject matter of any one of Examples 1-11 can optionally include an arrangement wherein the logic to detect an abnormal reading in the environmental condition comprises logic, at least partially including hardware logic, to determine whether a current reading for a fluid pressure in the plumbing fixture exceeds a maximum fluid pressure in the plumbing fixture for a threshold period of time.

In Example 13, the subject matter of any one of Examples 1-12 can optionally include an arrangement wherein the logic to detect an abnormal reading in the environmental condition comprises logic, at least partially including hardware logic, to determine whether a current reading for a fluid pressure in the plumbing fixture is below a minimum fluid pressure in the plumbing fixture for a threshold period of time.

In Example 14, the subject matter of any one of Examples 1-13 can optionally include an arrangement wherein the memory comprises one or more preconfigured fluid pressure profiles which correspond to an abnormal reading in the environmental condition, and the logic to detect an abnormal reading in the environmental condition comprises logic, at least partially including hardware logic, to compare a current reading for a fluid pressure to the one or more preconfigured fluid levels for a threshold period of time.

In Example 15, the subject matter of any one of Examples 1-14 can optionally include an arrangement wherein the logic to construct a profile of the environmental conditions over time comprises logic, at least partially including hardware logic, to determine at least one of a maximum flow rate for the fluid in the plumbing fixture, an average flow rate for the fluid in the plumbing fixture, or a minimum flow rate for the fluid in the plumbing fixture.

In Example 16, the subject matter of any one of Examples 1-15 can optionally include an arrangement wherein the logic to detect an abnormal reading in the environmental condition comprises logic, at least partially including hardware logic, to determine whether a current reading for a flow rate in the plumbing fixture exceeds a maximum flow rate in the plumbing fixture for a threshold period of time.

In Example 17, the subject matter of any one of Examples 1-16 can optionally include an arrangement wherein the logic to detect an abnormal reading in the environmental condition comprises logic, at least partially including hardware logic, to determine whether a current reading for a flow rate in the plumbing fixture is below a minimum flow rate in the plumbing fixture for a threshold period of time.

In Example 18, the subject matter of any one of Examples 1-18 can optionally include an arrangement wherein the memory comprises one or more preconfigured fluid flow rate profiles which correspond to an abnormal reading in the environmental condition, and the logic to detect an abnormal reading in the environmental condition comprises logic, at least partially including hardware logic, to compare a current reading for a fluid flow rate to the one or more preconfigured fluid flow rates for a threshold period of time.

In Example 19, the subject matter of any one of Examples 1-18 can optionally include logic, at least partially including hardware logic, to detect when a surface proximate the sensor apparatus is wet, and in response thereto, to generate an alert.

In Example 20, the subject matter of any one of Examples 1-19 can optionally include wherein the alert comprises at least one of a location identifier, a time stamp, or a device identifier.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1-20. (canceled)

21. A sensor apparatus, comprising:
at least one sensor to detect a reading for an environmental condition proximate the sensor apparatus;
logic, at least partially including hardware logic, configured to:
detect an abnormal reading in the environmental condition;
generate an alert in response to the abnormal reading; and
a communication interface to transmit the alert to a remote electronic device.

22. The sensor apparatus of claim 21, wherein the at least one sensor comprises at least one of a pressure sensor, a flow sensor, a capacitive sensor, a resistive sensor, an optical sensor, a microwave sensor, an ultrasonic sensor, or a float sensor.

23. The sensor apparatus of claim 22, wherein sensor apparatus further comprises a local memory.

24. The sensor apparatus of claim 23, logic, at least partially including hardware logic, configured to:
monitor, on a periodic basis, one or more environmental condition readings proximate the sensor apparatus; and
store the one or more environmental condition readings in the local memory.

25. The sensor apparatus of claim 24, further comprising logic, at least partially including hardware logic, to construct a profile of the environmental conditions over time.

26. The sensor apparatus of claim 25, wherein the environmental condition comprises at least one of:
a fluid level in a plumbing fixture;
a fluid pressure in the plumbing fixture; or
a flow rate for a fluid in the plumbing fixture.

27. The sensor apparatus of claim 26, wherein the logic to construct a profile of the environmental conditions over time comprises logic, at least partially including hardware logic, to determine at least one of:
a maximum fluid level in the plumbing fixture;
an average fluid level in the plumbing fixture; or
a minimum fluid level in the plumbing fixture

28. The sensor apparatus of claim 27, wherein the logic to detect an abnormal reading in the environmental condition comprises logic, at least partially including hardware logic, to determine whether a current reading for a fluid level in the plumbing fixture exceeds a maximum fluid level in the plumbing fixture for a threshold period of time.

29. The sensor apparatus of claim 27, wherein the logic to detect an abnormal reading in the environmental condition comprises logic, at least partially including hardware logic, to determine whether a current reading for a fluid level in the plumbing fixture is below a minimum fluid level in the plumbing fixture for a threshold period of time.

30. The sensor apparatus of claim 27, wherein:
the memory comprises one or more preconfigured fluid level profiles which correspond to an abnormal reading in the environmental condition; and
the logic to detect an abnormal reading in the environmental condition comprises logic, at least partially including hardware logic, to compare a current reading for a fluid level to the one or more preconfigured fluid levels for a threshold period of time.

31. The sensor apparatus of claim 26, wherein the logic to construct a profile of the environmental conditions over time comprises logic, at least partially including hardware logic, to determine at least one of:
a maximum fluid pressure in the plumbing fixture;
an average fluid pressure in the plumbing fixture; or
a minimum fluid pressure in the plumbing fixture

32. The sensor apparatus of claim 31, wherein the logic to detect an abnormal reading in the environmental condition comprises logic, at least partially including hardware logic, to determine whether a current reading for a fluid pressure in the plumbing fixture exceeds a maximum fluid pressure in the plumbing fixture for a threshold period of time.

33. The sensor apparatus of claim 31, wherein the logic to detect an abnormal reading in the environmental condition comprises logic, at least partially including hardware logic, to determine whether a current reading for a fluid pressure in the plumbing fixture is below a minimum fluid pressure in the plumbing fixture for a threshold period of time.

34. The sensor apparatus of claim 31, wherein:
the memory comprises one or more preconfigured fluid pressure profiles which correspond to an abnormal reading in the environmental condition; and
the logic to detect an abnormal reading in the environmental condition comprises logic, at least partially including hardware logic, to compare a current reading for a fluid pressure to the one or more preconfigured fluid levels for a threshold period of time.

35. The sensor apparatus of claim 26, wherein the logic to construct a profile of the environmental conditions over time comprises logic, at least partially including hardware logic, to determine at least one of:
a maximum flow rate for the fluid in the plumbing fixture;
an average flow rate for the fluid in the plumbing fixture; or
a minimum flow rate for the fluid in the plumbing fixture.

36. The sensor apparatus of claim 35, wherein the logic to detect an abnormal reading in the environmental condition comprises logic, at least partially including hardware logic, to determine whether a current reading for a flow rate in the plumbing fixture exceeds a maximum flow rate in the plumbing fixture for a threshold period of time.

37. The sensor apparatus of claim 35, wherein the logic to detect an abnormal reading in the environmental condition comprises logic, at least partially including hardware logic, to determine whether a current reading for a flow rate in the plumbing fixture is below a minimum flow rate in the plumbing fixture for a threshold period of time.

38. The sensor apparatus of claim 35, wherein:
the memory comprises one or more preconfigured fluid flow rate profiles which correspond to an abnormal reading in the environmental condition; and
the logic to detect an abnormal reading in the environmental condition comprises logic, at least partially including hardware logic, to compare a current reading for a fluid flow rate to the one or more preconfigured fluid flow rates for a threshold period of time.

39. The sensor apparatus of claim 22, further comprising logic, at least partially including hardware logic, to:
detect when a surface proximate the sensor apparatus is wet, and in response thereto, to generate an alert.

40. The sensor apparatus of claim 21, wherein the alert comprises at least one of:
a location identifier;
a time stamp; or
a device identifier.
